(19) United States
(12) Patent Application Publication
(10) Pub. No.: US 2021/0133827 A1
(43) Pub. Date: May 6, 2021

(54) ANONYMOUS TEMPORARY COMMUNICATIONS BETWEEN CONSUMER USERS AND PROVIDER USERS

(71) Applicant: Lynn D. Gabbay, Culver City, CA (US)

(72) Inventor: Lynn D. Gabbay, Culver City, CA (US)

(21) Appl. No.: 16/670,428

(22) Filed: Oct. 31, 2019

(51) Int. Cl. G06Q 30/02; H04M 3/42; G06Q 30/06

(52) U.S. Cl. CPC G06Q 30/0281; G06Q 30/0625; H04M 3/42008; G06Q 30/0284

(57) ABSTRACT

Systems, applications and methods for anonymous temporary communication between a consumer user and a provider user. For instance, the system receives, from a consumer application instance, match criteria specified by the consumer user for selecting a provider user based on provider traits. The system selects the provider user from a pool of provider users using the match criteria, wherein the selected provider user comprises matching provider traits that satisfy at least some of the match criteria specified by the consumer user. The system provides an anonymous temporary connection between the consumer application instance of the consumer user and a provider application instance of the provider user.

### BACKGROUND

Conventional social media and communications systems are based on connections between identified contacts. Users of such systems are identified using some form of system-wide unique identifiers, such as usernames, phone numbers, email addresses, identifiers from external communication systems, or other forms of identification. Contact between users of these systems is achieved by the users addressing each other using these identifiers. These identifiers are persistent and allow tracking of the user's activities,

In a typical social media system, individual users choose a username as their identifier and create a user profile that describes that user, including information such as text and photos, or characteristics of the user such as age, gender, or location. Users may form connections with other users; these connections are sometimes called friends or first-level connections. In order to form these connections, the user must first have knowledge the other user's identifier. This is typically provided by the other user directly, but often other users are discovered through the social network or published content online.

Users may interact with friends, and sometimes with friends of friends on a limited basis. Users may engage in communications with a specific user or groups of users, e.g., all friends, all friends plus friends of friends, etc. These communications include messages, status updates, and long-form posts, including words and photographs.

During these interactions, users may earn status, in the form of reputation scores, “likes,” and other mechanisms to signify social worth. In addition, some systems allow for monetary rewards to be accumulated, using content-adjacent advertising, per-click payments, or direct payment from other users. Some systems allow for goods or services to be sold in addition to the other social media activities described.

Users may delete other users from their lists of friends and may restrict visibility into the details of their profiles. However, once a user's information has been shared on the system, public awareness of the user and the user's actions cannot be undone. Automated archival systems and capture by other users ensure that the user's actions are preserved indefinitely. This presents a risk of exposure for any user such systems.

In conventional systems, for a user to connect with another, one must discover the other using these publicly accessible identifiers, e.g., derived from published content. In such systems, the only option to avoid discovery would be for a user to forego publishing content.

### SUMMARY

In one embodiment, presented herein is a system for anonymous temporary communication between a consumer user and a provider user. The system receives, from a consumer application instance, match criteria specified by the consumer user for selecting a provider user based on provider traits. The system selects the provider user from a pool of provider users using the match criteria, wherein the selected provider user comprises matching provider traits that satisfy at least some of the match criteria specified by the consumer user. The system provides an anonymous temporary connection between the consumer application instance of the consumer user and a provider application instance of the provider user.

In another embodiment, a system for anonymous temporary communication between a consumer user and a provider user is presented. The system assigns provider traits to one or more provider users in a pool of provider users based on one or more of user generated information or system generated information by receiving information from a pool of consumer users via corresponding consumer application instances and the pool of provider users via corresponding provider application instances. The provider traits comprise one or more of categorical values, sets of categorical values, sets of tag values, numerical values, numerical ranges, timestamps, or geographic location values. The system receives, from a consumer application instance, match criteria specified by the consumer user for selecting a provider user based on the assigned provider traits. The match criteria specified by the consumer user comprise selections of provider traits, the selections comprising one or more of exact value matches, value containment in a set or range, optimization of a utility function based on provider traits, or Boolean logic operations on such selections. The system selects the provider user from a pool of provider users using the match criteria. The selected provider user comprises matching provider traits that satisfy at least some of the match criteria specified by the consumer user. The system provides an anonymous temporary connection between the consumer application instance of the consumer user and a provider application instance of the provider user. The system facilitates routing of data packets between the consumer application instance and the provider application instance, wherein the routed data packets do not include identifying information of the consumer application instance or the provider application instance.

In another embodiment, a method for anonymous temporary communication of data packets between a consumer user and a provider user is presented. The method receives, from a consumer application instance, match criteria specified by the consumer user for selecting a provider user based on provider traits. The method selects the provider user from a pool of provider users using the match criteria, wherein the selected provider user comprises matching provider traits that satisfy at least some of the match criteria specified by the consumer user. The method provides an anonymous temporary connection between the consumer application instance of the consumer user and a provider application instance of the provider user.

The above embodiments are exemplary only. Other embodiments are within the scope of the disclosed subject matter.

### BRIEF DESCRIPTION OF THE DRAWINGS

So that the manner in which the features of the disclosure can be understood, a detailed description may be had by reference to certain embodiments, some of which are illustrated in the accompanying drawings. It is to be noted, however, that the drawings illustrate only certain embodiments and are therefore not to be considered limiting of its scope, for the scope of the disclosed subject matter encompasses other embodiments as well. The drawings are not necessarily to scale, emphasis generally being placed upon illustrating the features of certain embodiments. In the drawings, like numerals are used to indicate like parts throughout the various views.

FIGS. 1A & 1B are block diagrams of a system for anonymous temporary communication, in accordance with one or more aspects set forth herein.

FIGS. 2A & 2B are flowcharts of a method for anonymous temporary communication, in accordance with one or more aspects set forth herein.

FIG. 3 is a flowchart of a method for anonymous temporary communication, in accordance with one or more aspects set forth herein.

FIGS. 4A-4C depict a graphical user interface of a consumer mobile application for anonymous temporary communication, in accordance with one or more aspects set forth herein.

FIGS. 5A-5D depict a graphical user interface of a provider mobile application for anonymous temporary communication, in accordance with one or more aspects set forth herein.

FIG. 6 is a block diagram of a computer system, such as that employed by components depicted in FIG. 1A.

Corresponding reference characters indicate corresponding parts throughout several views. The examples set out herein illustrate several embodiments, but should not be construed as limiting in scope in any manner.

### DETAILED DESCRIPTION

The present disclosure relates to methods and systems for establishing anonymous temporary connection between parties, such as a consumer user and a provider user. Advantageously, in one example, the systems and methods, generally stated, allow the following: a) a consumer user may communicate with a provider user regarding a topic chosen by the consumer user; b) the provider user is initially, and remains, a stranger to the consumer user and vice versa; c) the provider user matches criteria chosen by the consumer user; and d) there is no exposure of the identities of the users to one another by the systems and methods. Subsequent to a temporary communication between the parties, the parties cannot re-establish communications using any information provided by the systems and methods. In one implementation, the present technique allows for anonymous temporary connection of parties, such that parties may engage in communication based on shared interests, but such connection is terminated without the parties having a permanent ongoing connection. The types of communication include voice calling, video chatting, multi-player gaming, text messaging, etc. Further details of these systems and methods are provided below. A technical benefit of these techniques is allowing people to have genuine conversation without consequence.

By way of contrast, as noted above, conventional systems rely on known identification of parties, who permanently are aware of one another's identities. The parties in conventional social media and communications establish networks of relationships that are permanent, and can choose to interact with each other on a peer to peer basis. Conventionally, social media networks are created by affiliating parties based on friend relationships.

The disclosed techniques represent practical applications that advance the field of social media and communication by: (a) increasing the efficiency of allowing parties to meet new people and to have genuine one-on-one conversations with them without the risk of exposure presented by traditional social media; (b) providing security through anonymized communications so that users are more free to share information without worrying about the information being harvested or misused in a manner that can harm the users; and (c) preventing unwanted exposure of users. These techniques are rooted in computer technology, and use computerized techniques such as encryption, network communication, etc., to achieve anonymous temporary connection.

Although generally applicable, the techniques described herein have applicability in numerous fields beyond social media. For example, these techniques may be used in telemedicine, to connect patients with healthcare providers, financial services, manufacturing, supply chain logistics, etc. Other applicable fields for the present technique include any businesses where amateurs can help people over the phone for some purpose, such as computer help, practicing speaking a language, life coaching, etc. In addition, these techniques facilitate “bite-sized” solutions that can complete in a single anonymous temporary connection.

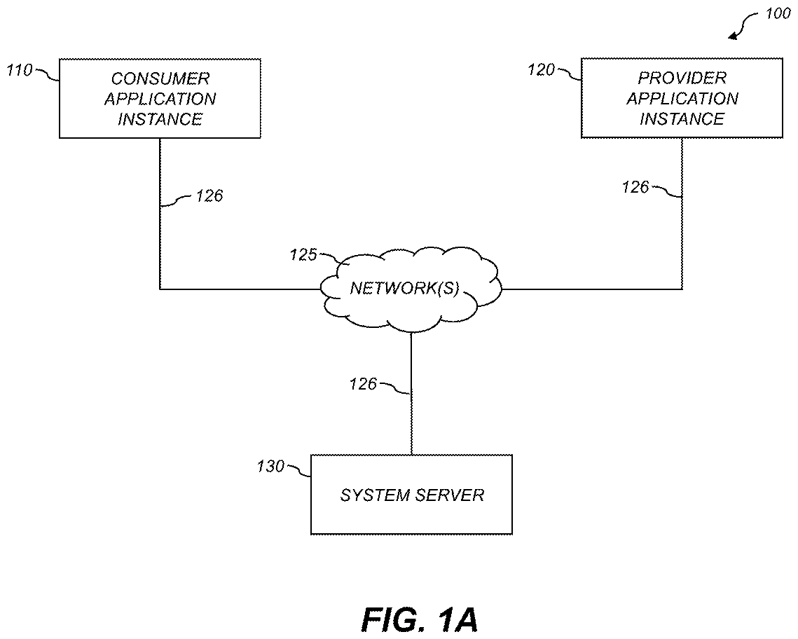

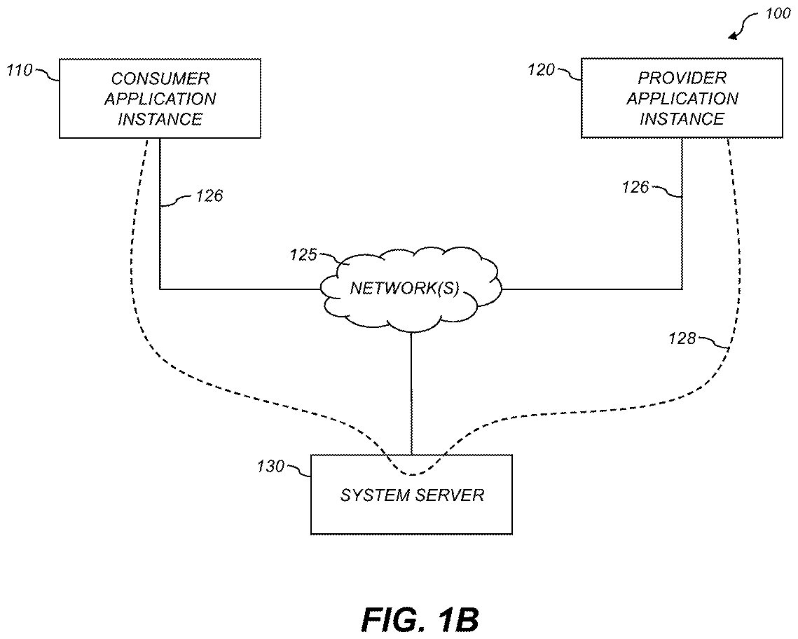

FIGS. 1A & 1B are block diagrams of a system 100 for anonymous temporary communication. In the embodiment of FIG. 1A, a system server 130 interoperates with numerous consumer users and provider users. For instance, a consumer application instance 110 runs on a mobile phone or other device and is controlled by a consumer user. In addition, a provider application instance 120 runs on a different mobile phone or other device and is controlled by a provider user. The instances 110, 120 and the system server 130 are connected to a network 125 via network connections 126. In addition, Numerous other consumer and provider users may be present in the system, but the ones controlling instances 110, 120 are depicted here for illustration purposes. In other embodiments, system server 130 is replaced with a cluster of servers, which may be geographically distributed.

FIG. 1B depicts an anonymous temporary connection 128 that has been established between the instances 110, 120. The anonymous temporary connection 128 is mediated or controlled by the system server 130. In one example, the system server 130 acts as a gateway or router to translate data traffic, such as packets, between the instances 110, 120. In another example, the system server 130 provides signaling so that other network devices (not shown) are configured to establish the anonymous temporary connection 128 and handle the flow of data packets. In another example, in order to optimize performance, the anonymous temporary connection may remove only a part of the identifying patent information, and thus may be a partially anonymous connection. Establishment of the anonymous temporary connection 128 takes place as described below. An application instance represents application software running on a specific device with specific inputs, e.g., logged in as a specific user. Applications can be run on mobile devices, desktop computers, embedded systems such as cars, kiosks, televisions, or any other computing device. In other embodiments, instead of separate consumer applications and provider applications, a single unified application may be deployed to both the consumer and provider. In such a case, the single unified application may provide the functionality described herein of either of the consumer or provider applications depending on how the user is logged into the application. Advantageously, a single unified application could also facilitate a single user acting as a consumer user or a provider user in different contexts through the same application.

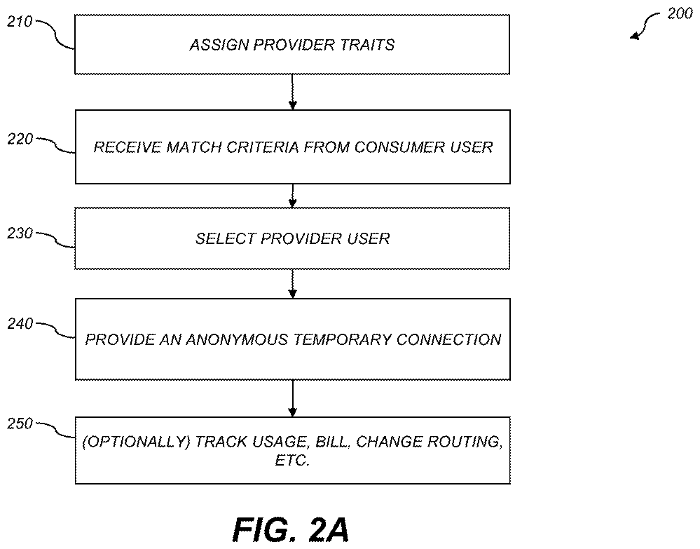

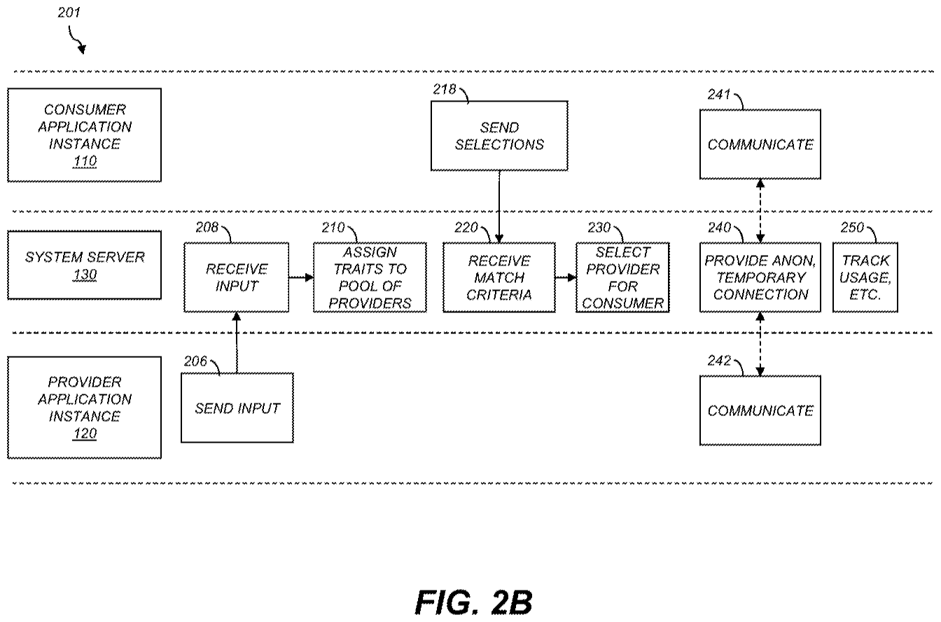

FIGS. 2A & 2B are flowcharts depicting methods for anonymous temporary connection between users, with FIG. 2A providing a general overview and FIG. 2B providing further specific details of one implementation of the method.

Continuing, FIG. 2A depicts a method 200 for anonymous temporary connection. In one embodiment, the method 200 at block 210 assigns provider traits to one or more provider users in a pool of provider users. The provider traits may be based on user generated information or system generated information. For example, the system may receive information from a pool of consumer users via corresponding consumer application instances and may also receive information from a pool of provider users via corresponding provider application instances. In such cases, the provider traits can comprise any number of traits in different formats. These traits may include one or more of categorical values, sets of categorical values, sets of tag values, numerical values, numerical ranges, timestamps, or geographic location values. Provider traits can express a wide range of information about the provider user without revealing the identity of that provider user. Provider users could specify some traits themselves, such as their location or languages they speak. The system could assign other provider traits based on feedback from consumer users, such as a friendliness score or a “top 10% in customer satisfaction” tag.

Next, the method 200 at block 220 receives, from a consumer application instance, match criteria specified by the consumer user for selecting a provider user based on the assigned provider traits. For instance, the match criteria specified by the consumer user could include selections of provider traits. These selections could follow one or more different formats. For example, the selections could include exact value matches, value containment in a set or range, optimization of a utility unction based on provider traits, or computational logic applied to the provider traits. Computational logic could include Boolean logic, with operators such as AND, OR, NOT, and could include multi-step program logic for making the selections. An advantage of using the match criteria specified by the consumer user to select the provider user from the pool is that the consumer can control the topics in the communication.

Next, the method 200 at block 230 selects the provider user from a pool of provider users using the match criteria, in such a case, the selected provider user would match provider traits that satisfy at least some of the match criteria specified by the consumer user. In other words, the selected provider user may match just some of the match criteria, or all of the match criteria. In one embodiment, the selecting includes randomly selecting the second user from a subset that constitutes partial matches. In another embodiment, the selecting includes calculating a compatibility score. For example, the compatibility score could weigh different traits and match criteria based on experiential learning of the system from the feedback provided by the users. In another embodiment, the selecting comprises calculating a utility function based on one or more of a waiting time and a compatibility score, thus balancing between waiting too long for a perfect match and being too quick to allocate a lesser match. In one embodiment, the provider user may be presented with the option to accept or decline the match prior to initiating the anonymous temporary connection, e.g., by being asked if the provider user wants to start a call with a specific consumer. In addition, the consumer user may be presented the option to accept the anonymous temporary connection, e.g., by being asked if the consumer user would like to answer an incoming, call from the provider user. Advantageously, the multi-step process of matching a consumer and provider allows for the system to gather, store, and manage the characteristics of the providers, and then as a consumer makes a request, match the consumer to the provider. This process represents a practical application of these technologies to solve the problem of having better matching between consumer users and provider users without revealing personal information, because the consumer user never knows which provider user is being selected, and just knows that the selection was consistent with the consumer user's preferences.

Next, the method 200 at block 240 provides an anonymous temporary connection between consumer and provider users. In general, the anonymous temporary connection may facilitate the routing of data packets between the parties. The connection may be encrypted, use address translation, or other methods for anonymity. Thus, the system could either perform the data packet routing itself, or could offload the routing to external systems while controlling signaling for establishing the connections. In one embodiment, an option to accept, decline or terminate the anonymous temporary connection is presented. In another embodiment, providing the anonymous temporary connection includes receiving data packets from the first application instance and the second application instance, removing identifying data from the data packets, and routing the data packets between the first application instance and the second application instance. In a further embodiment, providing the anonymous temporary connection comprises providing one or more of a voice over Internet Protocol (VoIP) connection, a public switched telephone network (PSTN) connection, or a data connection between the first application instance and the second application instance. In another embodiment, the connection supports one or more of a voice stream, a video stream, a data stream, or a text message stream. Although anonymous temporary connections could be as simple as a voice stream, these could be more sophisticated. For example, consider the scenario where a consumer user wishes to learn to play chess. The consumer user could request to be matched with a chess grandmaster, and the connection could be comprised of a voice stream and a game of chess played digitally and communicated over a data stream. From a technical standpoint, an anonymous temporary connection would be unachievable without using the computerized process described herein (e.g., system mediation of the connection, address translation, encryption, and the like), and no analogy may be drawn between an anonymous temporary connection and in-person or pen-and-paper techniques.

Next, the method 200 at block 250 can perform other optional functions, such as tracking usage, billing, changing the routing during the connection, etc. In another embodiment, billing the consumer user is based on a first financial calculation and crediting the provider user is based on a second financial calculation. In such a manner, the system can balance between supply and demand, offer so-called “surge pricing,” etc.

FIG. 2B is a flowchart depicting another implementation of a method 201 for anonymous temporary connection. In the embodiment of FIG. 2B, the method 201 is performed by processor(s) system server 130, the processor(s) that are running consumer application instance 110, and the processor(s) that are running provider application instance 120.

FIG. 2B shows 3 horizontal lanes with a component on the left and method steps performed by that component, in an embodiment, indicated to its right in the same horizontal lanes. However, in different embodiments, the different steps of the method may be performed by other components, such as in a situation where multiple roles are performed by a single computer system. Also, note that while a single consumer and provider are shown for ease of exposition of the concepts herein, an operational system can include hundreds, thousands, or millions of consumers and providers.

Continuing now with FIG. 2B, the provider application instance 120 performs the step of the method 201 at block 206 to send input to the system server 130. For example, through the use of a graphical user interface, such as the graphical user interfaces of FIGS, 5A-5D, each provider user interacts with the system to provide parameters describing that provider user's areas of interest, expertise, etc. The system server 130 performs the step of the method 201 at block 208 to receive these parameters from the provider application instance 110, and store the data for fixture use. Next, the system server 130 performs the step of the method 201 at block 210 to categorize all of the provider users from whom input has been received. For instance, a database may be created including all of the provider users and their responsive parameters. In addition, the system may also provide automatically some information about the provider user, e.g., verified by third parties such as background checks, etc. A variety of mechanisms may be used to maintain the pool of providers. Databases are well suited for this purpose, as they are designed for searching through records and finding optimal matches, and consumer specified match criteria map well to such queries. For scalability, the pool of providers could be internally subdivided into further sub-pools of providers, each implemented by its own database.

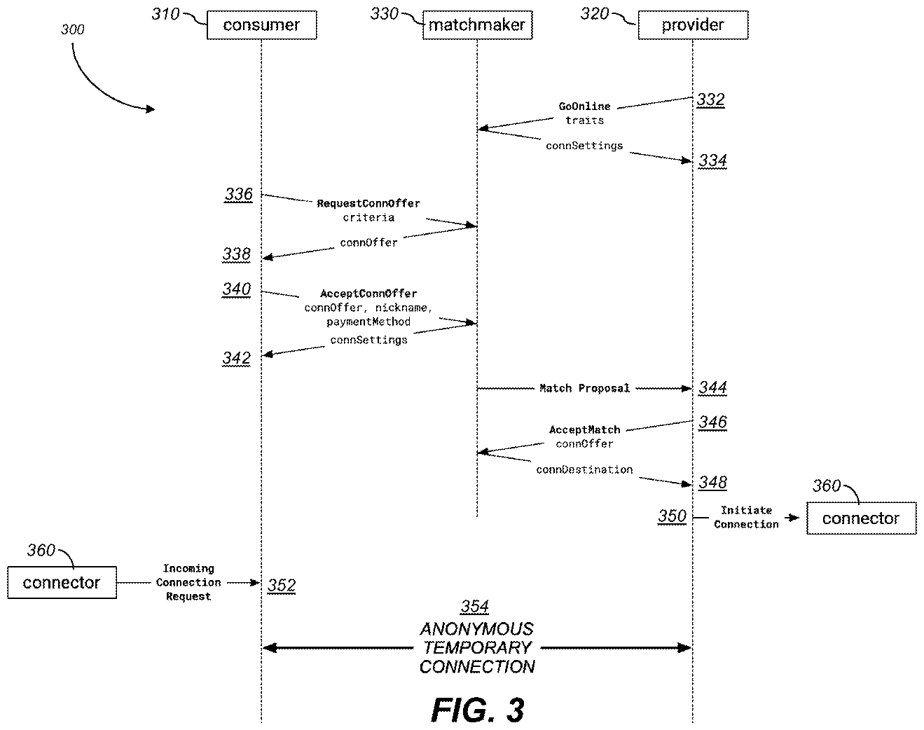

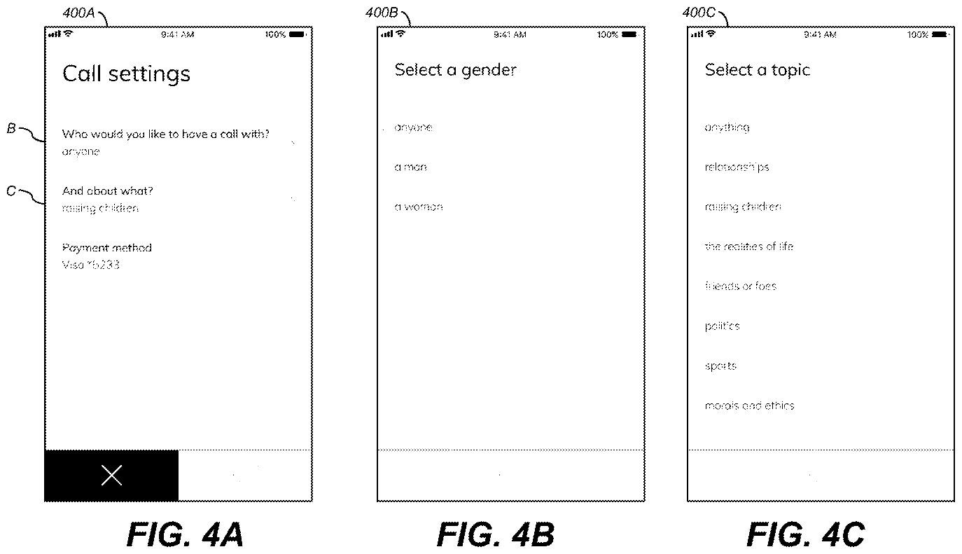

Next, the consumer application instance 110 performs the step of the method 201 at block 218 to send selections of match criteria to the system server 130. For example, through the use of a graphical user interface, such as the graphical user interfaces of FIGS. 4A-3C, each consumer user interacts with the system to provide parameters describing that consumer user's areas of interest or issues for discussion. Next, the system server 130 performs the step of the method 201 at block 220 receive the match criteria from the consumer application instance 110. Subsequently, the system server 130 performs the step of the method 201 at block 230 to select a provider that matches the needs of the consumer. For example, as explained above, all of the different providers may be categorized and scored against the needs of the consumer, and one of the highest scoring providers may be selected.

After selecting the provider for the consumer, the system server 130 performs the step of the method 201 at block 240 to provide the anonymous temporary connection between the consumer application instance 110 and provider application instance 120. Then, the consumer application instance 110 at block 241 communicates with the provider application instance 120 at block 242. During this communication, the system server 130 performs other optional steps of the method 201 at block 250, such as to track usage of the anonymous temporary connection, so that billing and crediting can be performed. The financial terms for billing consumer users and crediting provider users could be based on several factors derived from usage tracking. Some could be based on connection duration, such as a flat charge or credit or a per-minute charge or credit for a successful connection. Other factors might involve connection quality, network bandwidth consumption, or activities performed over the connection, such as playing a game of chess.

FIG. 3 is a flowchart depicting a method 300 for anonymous temporary connection between a consumer user 310 (e.g., via a consumer application instance) and a provider user 320 (e.g., via a provider application instance, using a system 330. At block 332 the provider user 320 goes online and interacts with the system 330, providing traits and characteristics of the provider user 320. Next, at block 334, the system 330 provides anonymized connection settings to the provider user 320.

Continuing, at block 336, the consumer user 310 requests a connection based on criteria of the consumer user's choice. At block 338, the server 330 presents the consumer user 310 with a connection offer; this is comprised of terms for the requested connection, such as the expected wait time and the financial terms for the requested connection. Next, the consumer user 310 at block 340 accepts the connection offer, providing a nickname and a payment method to the server 330. Then, the server 330 responds at block 342 with anonymized connection settings for the consumer user 310.

Next, at block 344 the server 330 proposes the match to the provider 320. The provider 320 at block 346 accepts the match, and the server 330 at block 348 provides anonymized temporary connection settings for the provider user 320 to connect to the consumer user 310,

Once the matching has completed, the connection is initiated at blocks 350, 352 using the anonymized settings, e.g. via a connector service 360 that establishes anonymous temporary connections. The system 330 then continues to track the call at block 354 for billing purposes. A variety of anonymous temporary connections are possible. Simple such connections could be voice over IP calls or text message streams. Other such connections could be more sophisticated, such as a consumer user and provider user talking over a voice stream while playing a game of chess over a data stream.

FIGS. 4A 4C depict a graphical user interface of a consumer mobile application for anonymous temporary communication. In the embodiment of FIG. 4A, graphical user interface 400A allows the consumer to select match criteria B and C, including a gender (B) and a topic (C), and selecting the payment method. For example, in the embodiment of FIG. 4B, graphical user interface 400B allows the consumer to select a gender. Next, in the embodiment of FIG. 4C, graphical user interface 400C allows the consumer to select the topic for the call.

The graphical user interface of the consumer mobile application interface may also include the following additional screens: a screen allowing the consumer to select the language spoken by the provider user; a screen allowing the consumer to select the personality type of the provider user; a screen allowing the consumer to request learn to play chess and selecting the chess ranking of the provider user.

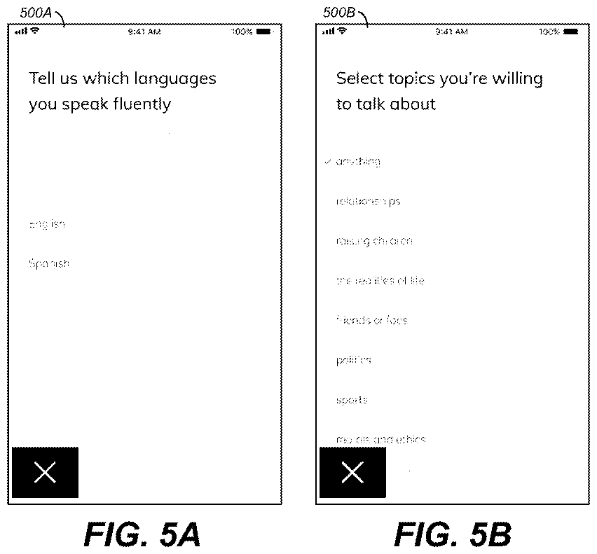

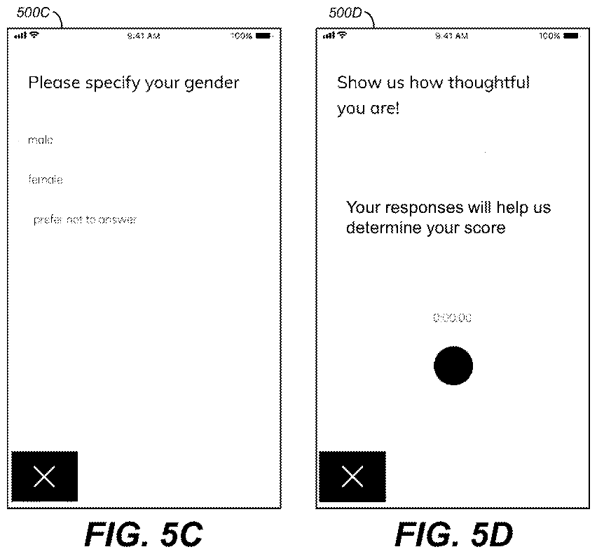

FIGS. 5A-5D depict a graphical user interface of a provider mobile application for anonymous temporary communication. In the embodiment of FIG. 5A, graphical user interface 500A allows the provider to specify their trait of the set of languages they speak fluently. Next, in the embodiment of FIG. 5B, graphical user interface 500B allows the provider to specify their trait of the set of topics they are willing to talk about. Next, in the embodiment of FIG. 5C, graphical user interface 500C allows the provider to input his or her gender. Subsequently, in the embodiment of FIG. 5D, graphical user interface 500D allows the provider to provide sample input demonstrating their knowledge of the topic. After the provider has provided a sample, they system can use the sample, along with prior responses, to calculate a score, such as a personality score, which may be one of the provider traits. The graphical user interface of the provider mobile application interface may also include the following additional screens: a screen allowing the provider to specify a set of tags; a series of screens asking personality questions to estimate their personality type; a screen allowing the provider to specify they are willing to play various one-on-one games, such as chess.

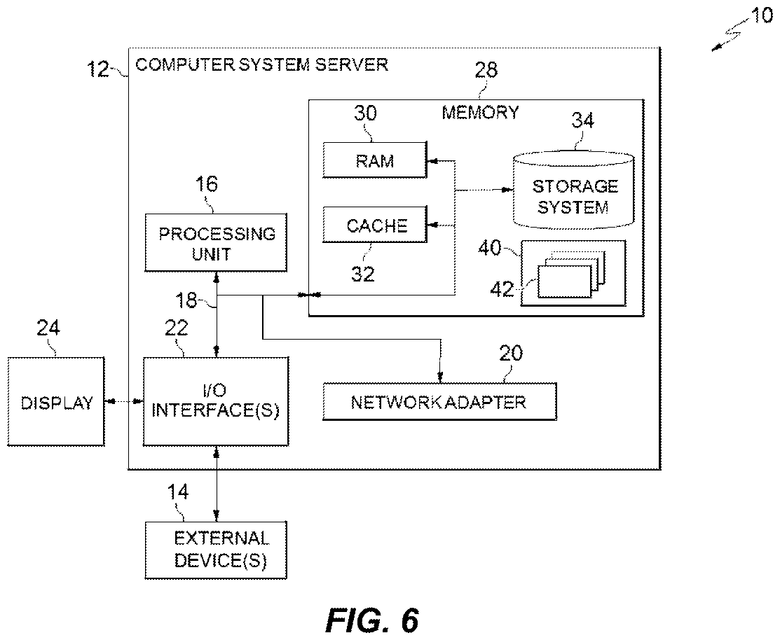

FIG. 6 is a block diagram of a computer system 10, such as that employed by the components of FIG. 1, e.g., for implementing methods 200, 201, 300, etc. A computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed environments where tasks are performed by remote processing devices that are linked through a communications network. In a distributed environment, program modules may be located in both local and remote computer system storage media including memory storage devices. Generally stated, the techniques described are an improvement to the field of telecommunications, and make use of computer-based technologies for their implementation.

Computer system/server 12 in computer system 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Embodiments may include a system, a method, and/or a computer program product. The computer program product may include a computer readable storage medium (or media) having computer readable program instructions thereon for causing a processor to carry out aspects of set forth herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the certain embodiments may be assembler instructions, instruction-set-architecture (ISA) instructions, machine instructions, machine dependent instructions, microcode, firmware instructions, state-setting data, or either source code or object code written in any combination of one or more. programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), in some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects set forth herein.

Embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved it will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system for anonymous temporary communication between a consumer user and a provider user, the system comprising one or more processors executing a plurality of instructions configured to:
receive, from a consumer application instance, match criteria specified by the consumer user for selecting a provider user based on provider traits;
select the provider user from a pool of provider users using the match criteria, wherein the selected provider user comprises matching provider traits that satisfy at least some of the match criteria specified by the consumer user; and
provide an anonymous temporary connection between the consumer application instance of the consumer user and a provider application instance of the provider user.

2. The system of claim 1, wherein the plurality of instructions is further configured to assign traits to provider users based on one or more of user generated information or system generated information by receiving information from a pool of consumer users via corresponding consumer application instances and the pool of provider users via corresponding provider application instances.

3. The system of claim 1, wherein providing the anonymous temporary connection comprises facilitating routing of data packets between the consumer application instance and the provider application instance, wherein the routed data packets do not include identifying information of the consumer user or the provider user.

4. The system of claim 3, wherein the facilitating comprises removing and/or replacing identifying data from the data packets.

5. The system of claim 1, wherein providing the anonymous temporary connection comprises providing one or more of a voice over Internet Protocol (VoIP) connection, a public switched telephone network (PSTN) connection, or a data connection between the consumer application instance and the provider application instance.

6. The system of claim 5, wherein the data connection facilitates one or more of text messaging, voice, video chatting, or gaming between the consumer user and the provider user.

7. The system of claim 1, wherein the provider traits comprise one or more of categorical values, sets of categorical values, sets of tag values, numerical values, numerical ranges, timestamps, or geographic location values.

8. The system of claim 1, wherein match criteria specified by the consumer user comprise selections of provider traits, the selections comprising one or more of exact value matches, value containment in a set or range, optimization of a utility function based on provider traits, or computational logic applied to the provider traits.

9. The system of claim 1, wherein the selecting comprises randomly selecting the provider user from a subset of the pool of provider users at least partially matching the criteria.

10. The system of claim 1, wherein the selecting comprises calculating a compatibility score between the consumer user and the provider user.

11. The system of claim 1, wherein the selecting comprises calculating a utility function based on one or more of a waiting time and a compatibility score.

12. The system of claim 1, wherein tracking the usage comprises billing the consumer user and crediting the provider user based on the usage.

13. The system of claim 1, further comprising billing the consumer user based on a first financial calculation and crediting the provider user is based on a second financial calculation, the billing being based on usage of the anonymous temporary communication.

14. The system of claim 1, wherein one or more of the provider traits are verified by a third-party.

15. A system for anonymous temporary communication between a consumer user and a provider user, the system comprising one or more processors executing a plurality of instructions configured to:
assign provider traits to one or more provider users in a pool of provider users based on one or more of user generated information or system generated information by receiving information from a pool of consumer users via corresponding consumer application instances and the pool of provider users via corresponding provider application instances, wherein the provider traits comprise one or more of categorical values, sets of categorical values, sets of tag values, numerical values, numerical ranges, timestamps, or geographic location values;
receive, from a consumer application instance, match criteria specified by the consumer user for selecting a provider user based on the assigned provider traits, wherein the match criteria specified by the consumer user comprise selections of provider traits, the selections comprising one or more of exact value matches, value containment in a set or range, optimization of a utility function based on provider traits, or computational logic applied to the provider traits;
select the provider user from a pool of provider users using the match criteria, wherein the selected provider user comprises matching provider traits that satisfy at least some of the match criteria specified by the consumer user;
provide an anonymous temporary connection between the consumer application instance of the consumer user and a provider application instance of the provider user; and
facilitating routing of data packets between the consumer application instance and the provider application instance within the anonymous temporary connection.

16. The system of claim 15, wherein the system further comprises a consumer mobile device and a provider mobile device, wherein the consumer mobile device includes one or more processor for executing instructions of the consumer application instance and the provider mobile device includes one or more processor for executing instructions of the provider application instance.

17. A method for anonymous temporary communication between a consumer user and a provider user, the method comprising computer executed steps of:
receiving, from a consumer application instance, match criteria specified by the consumer user for selecting a provider user based on provider traits;
selecting the provider user from a pool of provider users using the match criteria, wherein the selected provider user comprises matching provider traits that satisfy at least some of the match criteria specified by the consumer user; and
providing an anonymous temporary connection between the consumer application instance of the consumer user and a provider application instance of the provider user.

18. The method of claim 17, wherein the plurality of instructions is further configured to assign traits to provider users based on one or more of user generated information or system generated information by receiving information from a pool of consumer users via corresponding consumer application instances and the pool of provider users via corresponding provider application instances.

19. The method of claim 17, wherein providing the anonymous temporary connection comprises facilitating routing of data packets between the consumer application instance and the provider application instance, wherein the routed data packets do not include identifying information of the consumer user or the provider user.

20. The system of claim 16, wherein providing the anonymous temporary connection comprises providing one or more of a voice over Internet Protocol (VoIP) connection, a public switched telephone network (PSTN) connection, or a data connection between the consumer application instance and the provider application instance.
